(19) United States
(12) Patent Application Publication
(10) Pub. No.: US 2025/0376045 A1
(43) Pub. Date: Dec. 11, 2025

(54) Vehicle Torque Control Mechanism

(71) Applicant: BSL CH AG, Chur (CH)

(72) Inventor: Perry Jones, Mytchett (GB)

(21) Appl. No.: 18/875,974

(22) PCT Filed: May 17, 2023
(86) PCT No.: PCT/IB23/55065

§ 371 Date: Dec. 17, 2024

Related U.S. Application Data
(60) Provisional application No. 63/343,012, filed on May 17, 2022.

(51) Int. Cl. B60L 15/20; B60L 3/00

(52) U.S. Cl. CPC B60L 15/2036; B60L 3/003; B60L 2220/46; B60L 2240/463; B60L 2240/529

(57) ABSTRACT

A system is provided for controlling torque delivered by an electric motor over a dual inverter. In its primary embodiment, a Digital Differential Co-Processor (DDCP) connects with any automotive grade micro-controller that is principally concerned with controlling motor torque for two motors distributed on an axle.

### CROSS-REFERENCE TO RELATED APPLICATIONS

This application is a National Stage Entry of International Patent Application No. PCT/IB23/55065, which claims priority and benefit to U.S. Provisional Patent Application No. 63/343,012, filed on May 17, 2022, and titled Vehicle Torque Control Mechanism, the contents of which are incorporated herein by reference as though set forth in their entirety.

### FIELD OF USE

Embodiments relate to regulating torque delivered to multiple wheels of an electrically powered vehicle or an electrically powered trailer for use with a vehicle.

### BACKGROUND

Electric vehicles are starting to dominate the road. They are everywhere: electric cars, trucks, bikes, motorcycles, and all sorts of electric transports. Each of these electric vehicles have an electrical drive system that powers the vehicle's motor and ultimately the vehicle's traction system and wheels. The electrical drive system typically includes an automotive grade micro-controller (Integrated Circuit) that is controlled by embedded software.

In applications where the electric vehicle has multiple wheels across an axle, such as an axle with left and right wheels, a dual inverter may be used, whereby the left and right wheel of the vehicle are each controlled independently. Sometimes there is one micro-controller per side with a means of communicating between each side and sometimes there is one micro-controller controlling both sides at once.

In such applications, precise control is necessary under all conditions such that unintentional differential torque between the left and right wheel does not reach undue levels. For example, an unintended differential torque between left and right wheels of an electric vehicle might cause unintentional steering input for mechanically steered wheels.

### SUMMARY OF THE DISCLOSURE

In embodiments, a Digital Differential Co-Processor (DDCP) monitors and controls the torque delivered between the wheels of an electric vehicle or an electrically powered trailer. In embodiment, the DDCP is a chip (Integrated Circuit) that resides on a PCB inside a dual inverter that delivers power to the wheels of the vehicle. The inverter in question converts electrical power from a DC electrical supply and provides variable frequency AC electrical power to an IPM (Internal Permanent Magnet) Motor intended for electric vehicle traction applications.

In its primary embodiment, a DDCP connects with any automotive grade micro-controller (Integrated Circuit) that is principally concerned with controlling motor torque for two motors distributed on an axle with independent mechanical coupling via fixed ratio gear train on each side. In embodiments, a DDCP is designed to achieve some combination of the following objectives: (1) monitoring of primary control system input variables as transmitted from a micro-controller on a dedicated digital communications link; (2) predicting the necessary actions and control output adjustments that the host micro-controller must necessarily provide at regular time intervals to provide correct wheel torque balance; (3) alerting the micro-controller of any perceived discrepancies via the digital communications link; and (4) finally providing an ability to correct, independent of the micro-controller, any major deviations from predicted normal operation.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1 is a diagram of an embodiment of a dual inverter topology with a DDCP.

FIG. 2 is a diagram of an embodiment of an automotive grade micro-controller (Integrated Circuit) connected to a DDCP.

FIG. 3 is a diagram of an embodiment of a DDCP internal architecture.

FIG. 4 is a diagram that partially represents a typical steering and suspension setup at the front of a vehicle with driven front wheels.

FIG. 5 is a block diagram describing an embodiment of a vehicle control domain with hardware and software in the context of a DDCP.

FIG. 6 is an illustration of a Forward Clarke transform.

FIG. 7 depicts embodiments of an electrically powered vehicle and an electrically powered trailer incorporating a DDCP.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

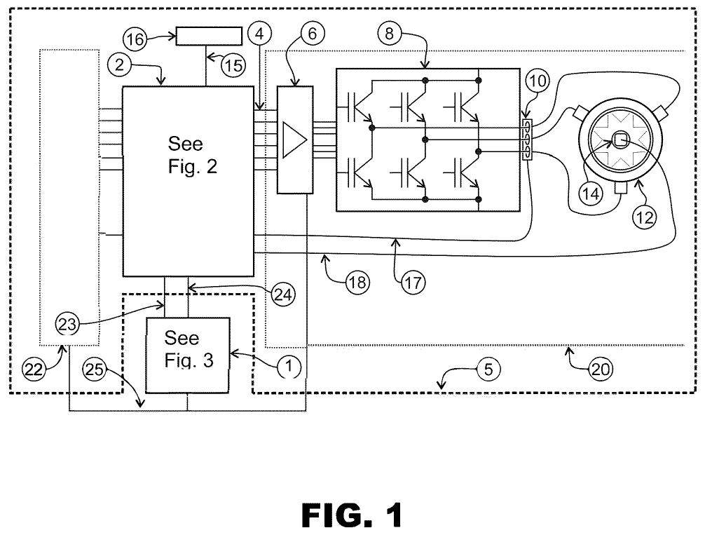

FIG. 1 is a diagram of an embodiment of a dual inverter topology with a DDCP 1. The area depicted inside the dotted line marked 20 is a complete right side of the embodiment dual inverter and vehicle drive inside the Motor Gearbox Assembly (MGA). There is an almost identical copy for the left side marked 22, abbreviated for clarity.

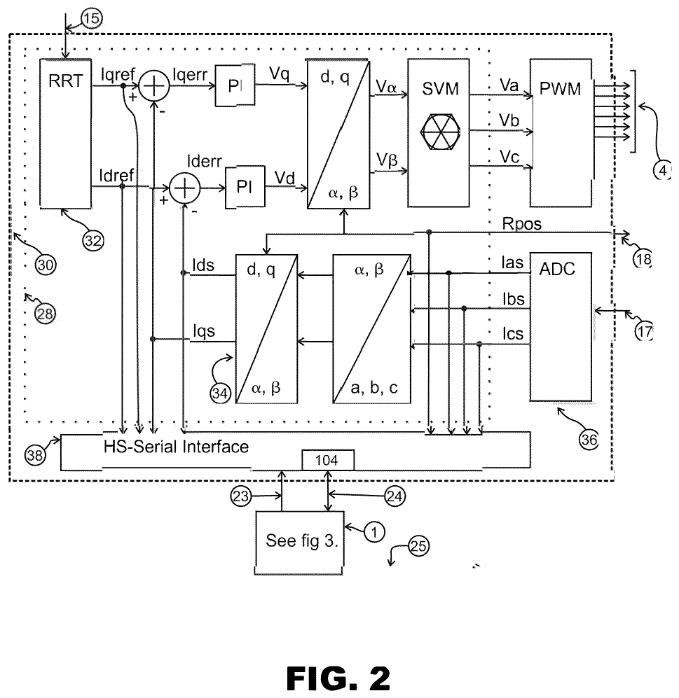

Referring to FIG. 1, an embodiment of a dual inverter topology is shown. Dual inverter 5 is connected to a right side of a vehicle drive 20 and a left side of a vehicle drive 22. A vehicle controller 16 receives information from vehicle systems, including driver inputs like the accelerator pedal input and the vehicle direction control, and also inputs from the vehicle stability system (ABS/ESC). The vehicle controller 16 issues torque command requests to the inverter 5 over a vehicle communications network 15. The inverter 5 has a micro-controller 2 (shown in FIG. 2). The inverter's micro-controller receives the torque command requests and then controls both the left 22 and the right 20 sides of the inverter 5.

Using established control techniques embodied in software, including Field Oriented Control (FOC) and Space Vector Modulation (SVM), an embodiment of the inverter's micro-controller uses pulse width modulation outputs 4 and driver circuits 6 to switch on and off an array of Insulated Gate Bipolar Transistors (IGBT) 8 that are connected to a DC Bus (not shown). This causes an alternating sinusoidal voltage to appear between each of the three phase connections with an alternating current flow, which in turn induces a rotating magnetic field inside an IPM (Internal Permanent Magnet) Synchronous Motor 12.

In embodiments, sinusoidal currents that are developed in the individual phase connections and windings inside the motor are measured and used by software inside the micro-controller 2 of the inverter 5 to provide feedback for a Proportion Integral (PI) control algorithm, which sets the desired torque. Acceptably accurate phase current measurements can be achieved by using a hall effect current transducer array 10 and by connecting the developed signals to the micro-controller of the inverter 5 via its analogue inputs 17.

In embodiments of the inverter's micro-controller, instantaneous phase current measurements are, via a process of sequential numerical transformations, turned into two values that represent, in DC form, what the PI control algorithm needs to know about the instantaneous motor torque. The algorithms involved include both Forward and Inverse Clarke-Park transforms. These calculations are typically performed at the same rate as the PWM frequency. In embodiments, in order for these transforms to work correctly, there must be an accurate value for the rotor position at all times. This is typically provided by a resolver 14 mounted on a motor shaft and connected to digital inputs on the micro-controller 2 of the inverter 5 via connector 18.

FIG. 2 is a diagram of an embodiment of an automotive grade micro-controller (Integrated Circuit) showing various software (SW) and hardware (HW) processes defined inside the micro-controller, but only one side for clarity. An embodiment of a DDCP 1 is connected via a High-Speed Serial Interface (HSSI) 24, and the individual interfaces in the DDCP 39 and the micro-controller 38 through which they exchange data packets. Information from the micro-controller arriving in the DDCP HSSI interface 39 via data packets is stored in the pSTATUS registers 102 and is thus available to be processed by the DDCP. The area outlined in dotted lines marked 28 represents functions and algorithms in the form of SW. The dotted outline marked 30 represents part of the micro-controller (one side only), including some of its built-in HW peripherals.

In order to monitor the inverter 5, embodiments of the DDCP 1 require several data objects that are created as part of the typical operational architecture inside the inverter's micro-controller (FIG. 2). In embodiments, the micro-controller (FIG. 2) uses a torque demand coming in from the CANBUS 15 and presents it to the RRT (Reactive Reluctance Torque) SW control block 32. The RRT SW control block 32 embodies the Field Oriented Control (FOC) algorithm which then takes the magnitude of the requested torque value and performs a calculation that determines where to set the Iqref and Idref values. The Iq and Id values are used inside the micro-controller and are two components of a vector that define the magnitude and direction of a field from the stator inside the IPM Motor. The size of these two values determines whether the motor is running in reluctance mode or reactance mode or a mixture of the two depending on the size of the torque request. Both Id and Iq remain constant during steady-state conditions. Id, Iq, and the reference values Idref and Iqref for each when compared with the measured values Ids and Iqs, generate error values Iderr and Igerr. The Id reference controls rotor magnetizing flux while the Iq reference governs motor torque output.

In embodiments, the Iqerr and Iderr values are then used as references for a PI (Proportional Integral) control loop. Through a series of numerical transformations using the rotor position signal 18 and involving Inverse Park and Clarke transforms, the micro-controller maintains and adjusts PWM values inside the PWM on chip peripheral to provide the necessary PWM signals 4 to drive the IGBT module 8 via the drivers 6. The torque control loop uses the requested values from the RRT block and compares them against measured Iq and Id values (Iqs and Ids) coming from the motor to generate an error signal. The measured Iqs and Ids are derived from the measured motor currents Ias, Ibs, and Ics coming into the micro-controller via the ADC inputs 17.

Another set of numerical transformations inside the micro-controller involving the rotor position signal 18 and Forward Clarke and Park transforms is what processes Ias, Ibs, Ics, and Rpos and results in measured values for Ids and Iqs.

In embodiments, the DDCP 1 monitors the dual inverter control system (embodied in SW and HW inside the micro-controller of FIG. 2) by receiving data in the form of HSSI data packets via the HSSI interface 39 and which are stored in the pSTATUS registers 102.

The data set from the micro-controller stored in the pSTATUS register, contains the values for Iqref, Idref, Iqerr, Iderr, Ias, Ibs, and Ics and the rotor position Rpos. In embodiment, this data is time-synchronous set, such that it represents the instantaneous state definition from the micro-controller at a particular point in time. For example, during each PWM cycle. It is not necessary for the DDCP 1 to do this calculation at every PWM interval. In embodiment, the DDCP 1 monitoring function takes periodic samples of the state of the control loop inside the micro-controller. Time intervals of the samples can be predetermined based on vehicle functional safety.

In embodiments, the necessary data for monitoring the inverter 5 is assembled and sent at pre-defined intervals to the DDCP 1 by the micro-controller 2 via the HSSI interface connection 24. In embodiments, a duplicate set of HW functions are present inside the DDCP 1 for the other side of the dual inverter, abbreviated for clarity in the block indicated by the dotted outline marked 40, which contains the same elements as the block marked 42.

In embodiments, the DDCP 1 determines if any pre-conditions for wheel torque imbalance are present. In order to do this, two main operations are undertaken in HW. Firstly, a Kirchoff sum checker 52 is used to add the instantaneous phase current values being transmitted over HSSI; the algebraic sum of these phase currents should, within predefined margins, be substantially zero. If the algebraic sum of these phase currents is zero, within acceptable limits, a resulting signal KGOOD is fed to the SDR (SAFE Decision Resolution) control block 46.

In embodiment, another HW block in the DDCP 1 is used to create an error signal based on its own set of Idq and Iqs values and the incoming Iqref and Idref target values that the micro-controller is trying to achieve in its PI control loop.

In order to produce the necessary equivalent Ids and Iqs values, the DDCP contains the same numerical transformation chain, but implemented in HW instead of SW. The Forward Clarke 50 and Forward Park 48 blocks perform this function. The error signals, which should be the same as the micro-controller is seeing, are used by the CV (Control Valid) block 54 to create a signal, CGOOD that indicates if the Iderr and Iqerr are within pre-defined limits.

In embodiments, the SDR control block 46 monitors the CGOOD and KGOOD signals and makes a decision based on prevalence of the condition of either of these two signals to decide whether to action a non-SAFE indication. In order to make time-dependent decisions, the SDR 46 requires an independent time reference created by the oscillator 44. A non-SAFE indication is transmitted to the micro-controller in two ways: by sending a dSTATUS frame and by setting a flag in one of the dSTATUS registers 104 stored inside the HSSI interface 38, and by asserting a HW interrupt 23 to alert the micro-controller. There is also a HW signal called SAFE 25 that is used by the inverter HW to decide if an inverter shutdown or other operation supporting the vehicle safety case is necessary.

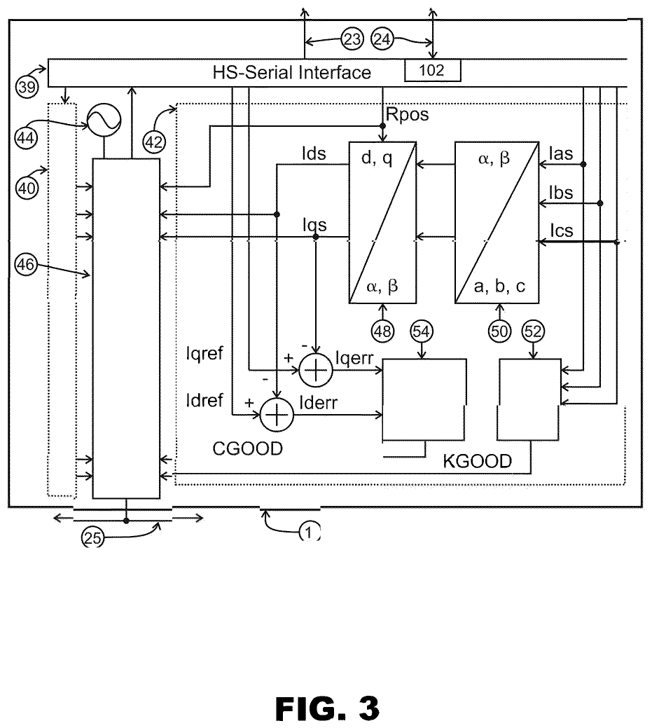

FIG. 3 is a diagram of an embodiment of a DDCP internal architecture showing an embodiment of the internal organization of a DDCP 1 connected at PCB level by a HSSI 24, a hardware interrupt signal 23 and a SAFE signal 25. In embodiments, the DDCP 1 is connected to the inverter 5 HW by several signals, for example, a HSSI connection 24, a HW interrupt signal 23 and a SAFE signal 25.

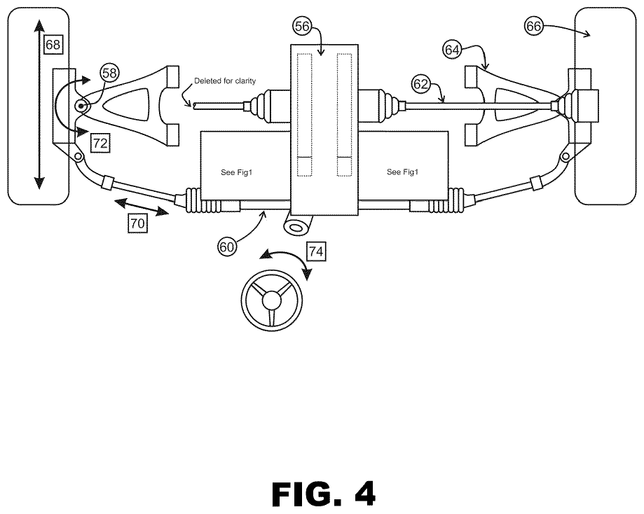

FIG. 4 is a diagram that partially represents a typical steering and suspension setup at the front of a vehicle with driven front wheels. At the center is a representation of the dual Motor Gearbox Assembly (MGA) 56. The main DDCP embodiment is most applicable but not limited to an application where the MGA contains two independent fixed ratio gear trains; one per side, and where they are not mechanically linked. The MGA provides balanced traction power to the wheels 66 via its two drive shafts 62. Part of the suspension called the lower control arm 64 is shown to highlight where the wheel and hub rotates at the pivot 58. The purpose of the diagram is to illustrate how an abrupt change to the motor torque that is isolated to one side of the MGA, and that is not matched by a balanced effect on the other side, can cause a chain of events. Typically, in such an abrupt torque event, there would be a sudden change in the force at the interface between the tire and the road surface 68. It is possible on variations of typical steering geometries for the event to cause an unintended steering moment or steering torque 72 around the pivot 58. By means of the fixed steering linkages of the steering system 70, the abrupt steering moment translates to longitudinal force on the steering rack 60 and thus to abrupt feedback on the steering wheel via the steering column 74. It is generally accepted that this is a hazard in functional safety terms of reference and must be avoided by the deployment of safety measures.

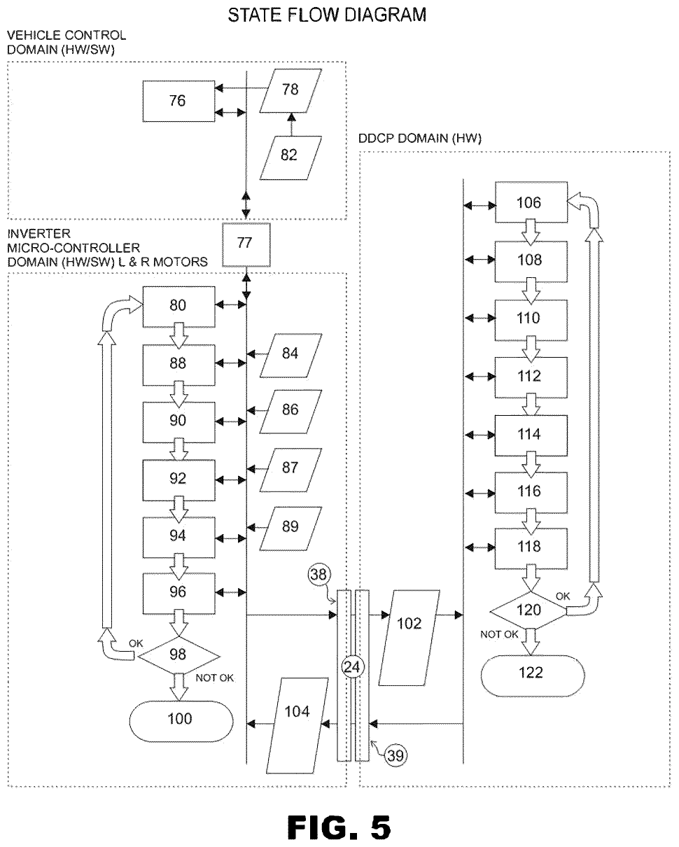

FIG. 5 is a block diagram describing an embodiment of a vehicle control domain with hardware and software in the context of a DDCP 1. In FIG. 5, a state flow diagram shows an enclosed area labeled vehicle control domain with both hardware (HW) and software (SW). This enclosed area is an embodiment intended as a typical representation to give context to the DDCP 1. Although a vehicle controller performs many functions in HW/SW, the following describes how it can perform in relation to controlling an inverter. Inside the vehicle controller, a pedal map 76 processes a driver torque request from an accelerator pedal and its ramp rate. A driver torque request is processed along with system input signals to set an inverter torque demand value that is sent to an inverter micro-controller via the vehicle communication interface 77.

In embodiments, also within the vehicle control domain, system input signals 78 are generated as part of the vehicle communications infrastructure and enter the inverter micro-controller via a vehicle communication interface 77 as system input signals. In embodiments, these input signals provide information needed to set a torque demand value inside the inverter micro-controller. The system input variables are created inside the micro-controller and are derived from the system input signals. The variables are used in numerous places in the SW algorithm flow diagram.

The following are system input signals 78 that can potentially be used as variables in the SW algorithm:
Accelerator Pedal—driver torque request input.
ABS/ESC—the signals that tell the micro-controller when ABS or ESC activity is happening.
Vehicle Speed—allows the inverter controller to choose the most optimal energy efficiency.
DC Link Voltage—a battery voltage helps define the torque demand limit.
Drive Mode—motor direction.
Battery SOC—the state of the battery can be used to initiate economy mode if the SOC is low.
Steering Position—if available can help with the torque demand balance between left and right motors when cornering.

In embodiment, also within the vehicle control domain are disturbance inputs 82. Below are examples of real-world disturbance inputs that may affect the torque request value by influencing the system input signals entering the vehicle controller:
Road Surface—uneven surfaces.
Wheel Slip—low mu or split mu conditions where less than perfect tire to road contact is achieved.

In FIG. 5, another enclosed area called an inverter micro-controller domain (HW/SW), L&R motors that depict some principal operations are performed by the inverter micro-controller in HW and SW. The steps below are executed synchronously for both left and right inverter controllers. All items including all variables have left and right versions. Registers have left and right components.

An embodiment of an inverter controller SW algorithm is shown in a flow diagram within steps 80 through 98 of FIG. 5, which represent SW that is executed in sequence called an ISR (Interrupt Service Routine). The ISR cyclically repeats at the same rate as the PWM frequency, typically 5 kHz or more. Other software functions are undertaken outside of the ISR, but they are not shown here for reasons of clarity. The steps shown below are for one side only, left- and right-sided versions are simultaneously executed.

At motor map 80, using the vehicle torque demand and the other system input variables, data are processed to calculate left/right motor balance and to calculate the correct motor current targets. This SW step includes setting the reluctance/reactance torque balance using Field Oriented Control (FOC) and MTPA (Maximum Torque Per Amp) methods which defines the amount of field weakening. The outputs from this step are new Idref and Iqref targets.

At feedback and PI controller 88, a main motor control function takes place. The following are input variables 84 for the controller:
Vehicle Torque Demand—how much torque is being requested from each motor.
Rotor Position (Rpos)—the exact instantaneous position for each rotor inside the motors which is used for converting between fixed and rotating reference frames and to calculate motor speed.
Ids—the instantaneous stator current that aligns with the rotating reference direction of the rotor magnetic axis. Calculated from the measured instantaneous phase currents Ias, Ibs, Ics, and Rpos.
Iqs—the instantaneous stator current that is at 90 degrees to the rotating reference direction of the rotor magnetic axis. Calculated from the measured instantaneous phase currents Ias, Ibs, Ics, and Rpos.

The following are control output variables 87 for the controller 88:
Idref—the target instantaneous stator current component that aligns with the rotating reference direction of the rotor magnetic axis.
Iqref—the target instantaneous stator current component that is at 90 degrees to the rotating reference direction of the rotor magnetic axis.
Iderr—the difference between Ids and Idref that is used to control the motor torque.
Iqerr—the difference between Iqs and Iqref that is used to control the motor torque.
Vd—the voltage excitation setting for the component of the voltage aligned with the rotating reference direction of the rotor axis.
Vq—the voltage excitation setting for the component of the voltage that is at 90 degrees to the rotating reference direction of the rotor magnetic axis.
Vα—the voltage excitation setting for the component of the voltage aligned with the phase a stator axis.
Vβ—the voltage excitation setting for the component of the voltage that is at 90 degrees to the phase a stator axis.

At the feedback and PI controller 88, using the requested Idref and Iqref currents, a comparison is made between the measured Ids and Iqs values in the feedback and PI controller 88. The comparison produces the error values Iderr and Igerr. These error values are submitted to the PI (Proportional Integral) control algorithm. The micro-controller influences Id and Iq by adjusting the voltage excitation on the motor, a calculation that uses a back EMF estimator based on motor speed, a value derived from the rate that Rpos changes over time. The new Vd and Vq values are submitted to the inverse park transform algorithm.

At inverse park 90, the rotating reference frame voltage values Vd and Vq are converted to signals referenced to a fixed axis. The following include some of the control input limits 86 for the inverse park 90:
Phase Current—the maximum allowed instantaneous value in amps for Ia, Ib, and Ic.
Battery Current—the maximum instantaneous battery current allowed.
RPM—the maximum motor RPM (revolutions per minute) allowed.
Torque—the maximum motor torque allowed.
Ramp Rate Up/Down—the maximum rate at which torque may be increased/decreased.
Deadtime—the minimum time between ON/OFF PWM transitions on opposing IGBTs to protect from short circuits.
CGOOD/KGOOD Threshold—the maximum allowed number of times each threshold can be breached in the safety test 98 before the SAFE state 100 is entered.

Execution of the Inverse Park transform using the current rotor reference position (Rpos) generates Vα and Vβ values and these are submitted to the SVM (Space Vector Modulation) algorithm.

At SVM 92, the SVM (Space Vector Modulation) algorithm is executed, which determines the optimal switching pattern for the IGBTs in the inverter. This determines the required PWM settings for each of the three sinusoidally varying motor phase voltages Va, Vb, and Vc. These values are found at the control state vector 89:
Va—the voltage excitation setting for the phase a motor connection.
Vb—the voltage excitation setting for the phase b motor connection.
Vc—the voltage excitation setting for the phase c motor connection.

At PWMs 94, the PWM values are updated observing deadtime limits.

At counters 96, timing of certain algorithmic functions can be managed by counters that increment at each PWM cycle, as some functions do not need to be executed every PWM cycle. In embodiment, the counters 96 trigger as frequently as the function requires. One of the counters determines how frequently to do a DDCP Update. If it is time to do an update, two things happen here: the result of the last update is read from the dSTATUS registers 104 by first checking the dRDY status flag and then incrementing two counters if the KGOOD and CGOOD flags are false. The KGOOD and CGOOD counters are incremented or decremented based on the prevalence of their value, true or false. The second thing that happens is the initiation of the next DDCP cycle; values are sent via the HSSI 24 and the interface 39 to the pSTATUS register 102 inside the DDCP and the pRDY is asserted true to start the DDCP algorithm.

At safety test 98, the inverter micro-controller conducts periodic safety checks using its own algorithms, for example, as a check on the results of DDCP operation. The KGOOD and CGOOD false count are compared against trigger thresholds that have been pre-defined and, if thresholds are not breached, the micro-controller returns to step 80. If either of the KGOOD or CGOOD counts breach the threshold, the algorithm enters the SAFE state 100. The micro-controller's own safety checks may also lead to entering the SAFE state 100.

At SAFE state 100, a micro-controller SAFE shutdown procedure for L&R can be initiated. The PWMs are set to the safest state to protect against asymmetric torque balance between left and right motors.

At pSTATUS registers 102, the registers are modified by the micro-controller via the HSSI 39 and the pSTATUS frame. It contains a copy of the instantaneous values below captured when the DDCP update flag pRDY is set by the micro-controller:
Ias
Ibs
Ics
Idref
Iqref
Iderr
Iqerr
Rpos
pRDY

The descriptions for the values above are the same as the descriptions elsewhere in this document. The variables for both left and right inverters are sent, each value has a left and right version. pRDY is a flag set by the micro-controller to indicate that a valid frame has been sent.

In embodiments, as depicted in FIG. 5, there is a DDCP domain (HW) shown within an enclosed area. This area describes the algorithm executed inside the DDCP 1 in the form of a state flow diagram. There are left and right functions that operate simultaneously. Only one side is shown for reasons of clarity.

In embodiment, the states executed inside the DDCP 1 are shown between 106 and 122 of the DDCP state flow (HW) diagram.

At START 106, the DDCP checks pSTATUS register for an update from the host micro-controller. If pRDY is true, then proceed to the next step and set the KGOOD and CGOOD flags to true.

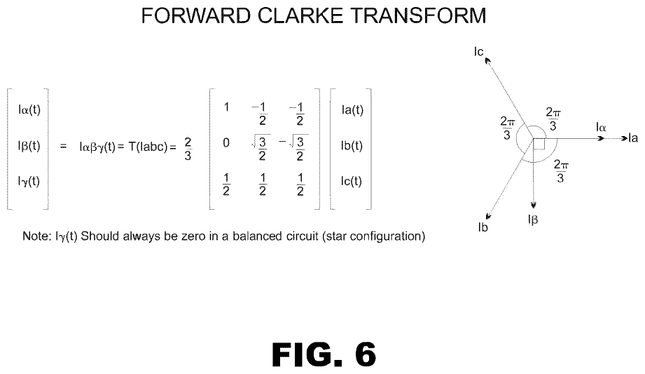

At Forward Clarke 108, load Ias, Ibs, and Ics values into the MMA (Matrix Multiply Accumulate) unit and, using the pre-defined coefficients, execute the Forward Clarke transform (see FIG. 6) resulting in the three values Iα, Iβ, and Iγ.

At Kirchoff Test 110 (also referenced by 52 in FIG. 3), check that Iγ is close to or equal to zero within pre-set margins and clear the KGOOD flag to false if not.

At Forward Park 112, load Iα and Iβ and Rpos values into the MMA unit and, using the pre-defined coefficients, execute the Forward Park transform resulting in Ids and Iqs.

At CV (Control Valid) Test (54 on FIG. 3), a function is comprised of two halves. At the first CV Test 114, compare the DDCP calculated Ids, Iqs and the micro-controller versions of the same values and within pre-set margins clear the CGOOD flag to false if the limits are breached. At the second CV Test 116, using the micro-controller Idref and Iqref values, calculate the local Iderr and Iqerr values and compare them with the micro-controller versions and clear the CGOOD flag to false if limits are breached.

At Update SDR 118, the SDR (Safety Decision Register) of which there are two-one for left and one for the right motor—the dSAFE, KGOOD and CGOOD flags and the KGOOD and CGOOD count values are contained. This step increments the KGOOD/CGOOD counters inside the DDCP if the KGOOD or CGOOD flags are false and decrements them if true. In embodiment, the KGOOD and CGOOD counters are completely independent from the ones inside the micro-controller where a separate count is maintained.

The CGOOD, KGOOD and dSAFE flags from each SDR are transmitted to the micro-controller via the HSSI connection 24 in the dSTATUS frame and are received by it at the dSTATUS registers 104.

At safety test 120, compare KGOOD and CGOOD false count against pre-set trigger thresholds. If the pre-set thresholds are breached, the next step is the SAFE state 122. If the test result is OK, the next step is START 106.

At SAFE state 122, this is the state in which the DDCP has determined that multiple KGOOD and/or CGOOD false counts have occurred and that predefined limits have been breached within a predefined time period. The micro-controller will have been receiving the same KGOOD and CGOOD false flags via the HSSI and will have reached its own resolution to enter its own SAFE state 100 by monitoring the dSTATUS registers. However, it is contingent upon the DDCP to communicate this state to the micro-controller based on the assumption that it will initiate SAFE shutdown procedures based on vehicle operating conditions if it hasn't already resolved to do so. Additionally, the DDCP may also initiate a SAFE shutdown independently of the micro-controller in such a way that if the micro-controller is in a locked up or other inoperative state, vehicle safety is maintained. The DDCP initiates a HW shutdown of the inverters by means of a direct connection between the SAFE output and the inverter driver circuits.

Typically, the events upon entering the DDCP SAFE state 122 would follow this sequence: the DDCP clears the dSAFE bit in the dSTATUS registers by sending the dSTATUS frame to the micro-controller. The DDCP SAFE output is asserted enabling HW inside both left and right inverters to begin an ordered shutdown into a safe operating mode based on vehicle operating conditions independently of the micro-controller. Inside the micro-controller SAFE state 100 will be entered because it has received an indication that the DDCP has entered SAFE state 122 and a SAFE shutdown procedure for L&R inverters is also initiated. The PWMs are set to the safest state to protect against asymmetric torque balance between left and right motors. At SAFE state 122, a HW Interrupt to the micro-controller can be asserted, which additionally alerts the micro-controller that an unSAFE state has been detected.

In considering the vehicle operating conditions it is necessary to determine what the most appropriate form of SAFE shutdown is for the inverters. For instance, at higher speeds, it is appropriate to produce even-balanced braking torque to both L&R motors until lower speeds are attained. At low speed this is not necessary, and torque can be set to zero. In SAFE state 100 the micro-controller may have entered this state on its own without the DDCP having caused this and will have the opportunity to control the SAFE shutdown procedure itself. In the event that the DDCP has entered SAFE state 122 and has caused the micro-controller to enter SAFE state 100 too, the shutdown caused by the assertion of the SAFE output HW signal will take precedence, although the micro-controller will be doing the same in parallel by way of redundancy.

The DDCP may also enter the SAFE state 122 if a pre-defined time limit has been breached since the last pSTATUS frame has been sent by the micro-controller. By this means, an independent watchdog function is performed and acts as a countermeasure in the event that the micro-controller is locked up or otherwise malfunctioning.

Embodiments incorporating one or more digital differential circuits are informative. For example, a DDCP can be used in a vehicle or a trailer attached to the vehicle, both of which can have separate propulsive electric axles. For example, in an embodiment, a tractor has a DDCP that monitors and controls the torque delivered between the wheels of the tractor, and a trailer attached to the tractor also has a DDCP that monitors and controls the torque delivered between the wheels of the trailer. In embodiments, the DDCP performs its differential function with regards to torque in the axles of the tractor, but also can perform a number of other functions associated with regards to propulsive axles in the trailer for accelerating, for regenerative braking and for detecting wheel slips that would inform of a potential jackknife incident taking place and apply preventative measure to help prevent that jackknife incident from fully occurring.

With a DDCP controlling the electric axles of the vehicle and the electric axles of the trailer, the DDCP is able to reduce emissions through the application of trailer propulsive boosting and regenerative braking, reduce fuel consumption through the application of trailer propulsive boosting and regenerative braking, and enhance safety through the application of electronic differential forces to the wheels to prevent jackknifing and so forth.

A majority of emissions caused by tractor unit or emitted by a tractor unit will be produced when the vehicle is accelerating as the engine will go through a transient operating mode with a high-power demand usually, and this will cause significant proportion of the emissions to be emitted during any givens drive cycle. In an embodiment, a gasoline vehicle utilizes a trailer having one or more axles with electric propulsion and a DDCP, wherein the one or more electric axles of the trailer help propel the entire tractor and electric axle trailer combination during acceleration phases and utilizes regenerative braking during deceleration phases. In embodiments, the electric propulsion sets in the trailer, controlled by the DDCP, provide tractive power to the tractor trailer combination and thereby help eliminate some of the peak power requirement of the tractor units, internal combustion engine and therefore mitigate against some of the worst emissions and some of the worst field consumption.

Trailer boost and regenerative braking efforts to date have faced the same challenges as truck conversions, requiring the weight and complexity of integrating a mechanical differential. In embodiments, DDCP digital differential and software controls not only perform ordinary differential functions, but also check wheel position for braking, acceleration setting and wheel slip monitoring for the tractor or the trailer. Decreased emissions, reduced fuel consumption, enhanced safety through wheel position monitoring, and high voltage refrigeration unit power support are all benefits in certain embodiments of an electric vehicle or trailer utilizing a DDCP.

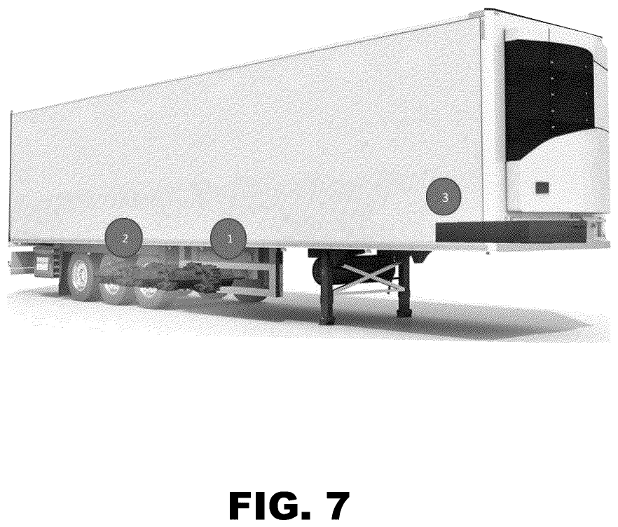

In embodiments, shown in FIG. 7, a common set of architectural components from an electric vehicle incorporating a DDCP, including propulsion systems, energy storage and management systems, and control systems can be easily integrated and deployed with a minimum level of risk into a standard twin-axle trailer, resulting in an entirely differentiated propulsion and regenerative braking “eBoost” trailer, leveraging the same software control modules, electromagnetics, electronics and battery management technology that exists in the electric vehicle connected to the trailer.

In FIG. 7, an embodiment of a trailer comprises Integrated Power Electronics 1, Digital Axels 2 (2× Motors per axle, 56 kw/1000 Nm), and a HV Traction Battery 3 (86 kWh LFP). In embodiments, the Digital Axel propulsion sets 2 are installed in-between the main frame rails of the trailer and an independent suspension is present for each wheel set. In embodiments, the Digital Axels 2 each are driven by their own twin-motor propulsion elements and a DDCP. In other embodiment, the Digital Axels 2 are controlled by a common DDCP.

In embodiments, the High Voltage Traction Battery 3 is configured to supply energy which will be used by the propulsion sets, and the same battery can be used to hold regenerated energy from the proportion sets, thus permitting operation of the trailer's propulsion sets as regenerative power sources when the vehicle is braking. Regenerative effort and the energy from braking, rather than being dissipated as heating dust, can be captured and then reutilized as propulsive energy when the time is needed.

Other embodiments may include combinations and sub-combinations of features described or shown in the several figures, including for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

References throughout this specification to “one embodiment,” “an embodiment,” “an example embodiment,” etc., indicate that the embodiment described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with one embodiment, it will be within the knowledge of one skilled in the art to affect such feature, structure, or characteristic in connection with other embodiments whether or not explicitly described.

Unless the context clearly indicates otherwise (1) the word “and” indicates the conjunctive; (2) the word “or” indicates the disjunctive; (3) when the article is phrased in the disjunctive, followed by the words “or both,” both the conjunctive and disjunctive are intended; and (4) the word “and” or “or” between the last two items in a series applies to the entire series.

Where a group is expressed using the term “one or more” followed by a plural noun, any further use of that noun to refer to one or more members of the group shall indicate both the singular and the plural form of the noun. For example, a group expressed as having “one or more members” followed by a reference to “the members” of the group shall mean “the member” if there is only one member of the group.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

What is claimed is:

1. A system for providing torque to two wheels across an axle, comprising a dual inverter, a Digital Differential Co-Processor (DDCP), and two electrically powered wheels across the axle, wherein the dual inverter provides torque to the two electrically powered wheels, and the DDCP monitors and controls the amount of torque delivered by the inverter to each of the two wheels.

2. The system of claim 1, wherein the DDCP determines if any pre-conditions for wheel torque imbalance is present by checking instantaneous phase current values being transmitted over a high-speed serial interface from a micro-controller connected to the dual inverter.

3. The system of claim 1, wherein the DDCP creates a signal based on measured Id and Iq values compared to incoming Idref and Iref target values from the dual inverter.
